(19) United States
(12) Patent Application Publication
(10) Pub. No.: US 2018/0336558 A1
(43) Pub. Date: Nov. 22, 2018

(54) Systems and Methods for Assessing Account Issuer Performance Relative to One or More Metrics

(71) Applicant: MASTERCARD INTERNATIONAL INCORPORATED, Purchase, NY (US)

(72) Inventors: Anne Valentzas, Irvington, NY (US); Andrew Pyper, Chatham, NJ (US); Christopher Brandon Wetzel, Glen Rock, NJ (US)

(21) Appl. No.: 15/597,618

(22) Filed: May 17, 2017

(51) Int. Cl. G06Q 20/40

(52) U.S. Cl. CPC G06Q 20/405; G06Q 20/4016

(57) ABSTRACT

Systems and methods are provided for assessing account issuer performance relative to one or more metrics. One exemplary method includes identifying a set of peer issuers for a target issuer based on at least one characteristic of the target issuer, determining an aggregate value of at least one metric for the identified set of peer issuers, and comparing the aggregate value to a value of the at least one metric for the target issuer of the at least one metric for the target issuer. The method further includes assigning an indicator to the target issuer, for the at least one metric, based on the comparison and transmitting the indicator to the target issuer, thereby responding to the request and permitting the target issuer to assess a performance of the target issuer relative to the identified set of peer issuers.

### FIELD

The present disclosure generally relates to systems and methods for assessing account issuer performance relative to one or more metrics, and in particular, to systems and methods for use in assessing performance of target issuers, relative to sets of identified peer issuers, as defined by one or more metrics, and providing indicators of the relative performance.

### BACKGROUND

This section provides background information related to the present disclosure which is not necessarily prior art.

Consumers are known to use one or multiple payment accounts to fund transactions for different types of products (e.g., goods and services, etc.), from different merchants. The transactions to the payment accounts result in transaction data, associated with authorization, settlement and/or clearing of the transactions, being compiled by, for example, the issuers associated with the accounts and the payment networks processing the transactions. The transaction data is known to be used, in combination with various algorithms, to provide services to the consumers and/or issuers, depending on the users of the transaction data. For example, transaction data is often used to build, deploy and improve marketing services, etc.

### DRAWINGS

The drawings described herein are for illustrative purposes only of selected embodiments and not all possible implementations, and are not intended to limit the scope of the present disclosure.

FIG. 1 is a block diagram of an exemplary system for assessing performance of target issuers, relative to sets of peer issuers, as defined by one or more metrics, and for providing indicators of the relative performance;

FIG. 2 is a block diagram of a computing device that may be used in the exemplary system of FIG. 1;

FIG. 3 is a flow diagram of an exemplary method, which may be implemented in connection with the system of FIG. 1, for assessing performance of a target issuer, relative to at least one peer issuer, as defined by at least one metric;

FIG. 4 is an exemplary interface associated with a network-based application for use by a target issuer to request a relative assessment, and which may be used in connection with the system of FIG. 1 and/or the method of FIG. 3;

FIGS. 5 and 6 are exemplary interfaces illustrating graphical comparisons of values for metrics associated with a target issuer to corresponding values for a set of peer issuers, and which may be used in connection with the system of FIG. 1 and/or the method of FIG. 3;

FIG. 7 is an exemplary mapping grid that may be used in the system of FIG. 1 and/or the method of FIG. 3 to identify recommendations for a target issuer for various metrics associated with the target issuer, based on indicators assigned to the target issuer for the metrics; and

FIG. 8 is an exemplary interface including multiple indicators for a target issuer, based on metrics associated with a set of peer issuers, and which may be used in connection with the system of FIG. 1 and/or the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Many issuers offer different types of payment accounts to consumers, which are then used by the consumers to fund payment account transactions. Payment accounts may include, for example, credit accounts, debit accounts, prepaid accounts, etc. In order to compete for consumers, issuers may offer rewards services in association with the payment accounts, special services and/or support for the payment accounts, etc. The rewards services, like other services/features of the payment accounts and/or processing services associated therewith, may be assessed, internally, for example, to determine if the issuers of the accounts are benefiting from the services. Uniquely, the systems and methods herein provide a profile of a target issuer, relative to a set of peer issuers, whereby one or more indicators associated with various metrics and/or associated with a relative performance of the target issuer are provided to the target issuer. In particular, for a target issuer, a set of peer issuers is identified, by a profile engine, based on aspects of the target issuer (e.g., issuer size, payment account type, etc.). The profile engine then compiles metrics for the set of peer issuers, and also for the target issuer, for comparison. And, the profile engine then assigns an indicator, for each metric, indicating the relative performance of the target issuer to the peer issuers. In turn, the indicators, and potentially additional information about the metrics, are transmitted by the profile engine to the target issuer. In this manner, the target issuer is able to evaluate and/or assess its performance relative to the set of peer issuers and, potentially, take action to improve its performance. In addition to the indicators and/or metrics, the profile engine may also identify and transmit one or more recommended actions to the target issuer. In this manner, the target issuer is further able to attempt to improve its relative performance based on the predefined recommendations, and may be able to more efficiently determine future actions, if any, to be taken in connection with its payment accounts and to compete more effectively against other issuers.

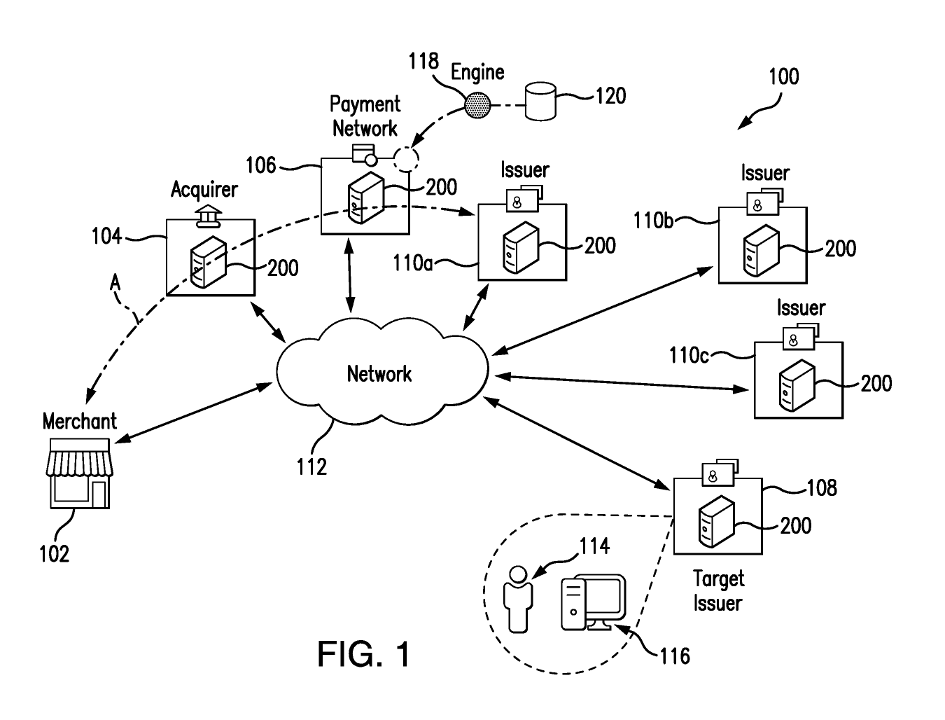

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, where transaction data is stored in the system 100; a number of merchants, acquirers, payment networks and/or issuers in the system; etc.

The system 100 generally includes a merchant 102, an acquirer 104 associated with the merchant 102, a payment network 106, a target issuer 108, and additional peer issuers 110a-c, each coupled to (and in communication with) network 112. The network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 112 may include multiple different networks, such as a private payment transaction network made accessible by the payment network 106 to the acquirer 104, the target issuer 108 and/or issuers 110a-c and, separately, the public Internet, which may provide interconnection between one or more of the merchant 102, the payment network 106, the target issuer 108, or the issuers 110a-c, etc.

The merchant 102 is generally provided to offer products (e.g., goods and/or services, etc.) for sale to consumers in the system 100. The merchant 102 may offer the products for sale in physical locations or through virtual locations (e.g., websites, etc.), as desired. When the consumer purchases a product from the merchant 102, often, the consumer funds the purchase through a payment account transaction with the merchant 102.

In one exemplary transaction, a consumer presents a payment device to the merchant 102, and specifically, to a point of sale (POS) terminal at the merchant 102, in order to fund the purchase of a product. The payment device (not shown) is associated with a payment account issued to the consumer by the peer issuer 110a. In turn, the POS terminal reads payment account credential(s) for the consumer's payment device from the payment device, and compiles and submits an authorization request for the transaction to the acquirer 104 (associated with the merchant 102), along path A, as referenced in FIG. 1. The acquirer 104 then communicates the authorization request with the peer issuer 110a (associated with the consumer's payment account), through the payment network 106 (e.g., through MasterCard®, VISA®, Discover®, American Express®, etc.) to determine whether the payment account is in good standing and whether there is sufficient funds and/or credit to cover the transaction. In turn, if the transaction is approved, an authorization reply or response (indicating the approval of the transaction) is transmitted back from the issuer 110a to the merchant 102, along path A, thereby permitting the merchant 102 to complete the transaction. The transaction is later cleared and/or settled by and between the merchant 102, the acquirer 104, and the issuer 110a by appropriate agreements. If the transaction is declined, however, the authorization reply (indicating the decline of the transaction) is provided back to the merchant 102, along path A, thereby permitting the merchant 102 to halt or terminate the transaction.

Although the above transaction is described with reference to the issuer 110a, it should be appreciated that a transaction to a payment account issued by either the target issuer 108 or the peer issuer 110b or the peer issuer 110c would be substantially consistent with the above described transaction.

Transaction data is generated, collected, and stored as part of the above interactions among the merchant 102, the acquirer 104, the payment network 106, and the issuer 110a (or for similar transactions involving the issuer 108 and/or the issuers 110b-c, as appropriate). The transaction data represents at least a plurality of transactions, for example, authorized transactions, cleared and/or settled transactions, attempted transactions, etc. The transaction data, in this exemplary embodiment, is stored at least by the payment network 106 (e.g., in a data structure associated with the payment network 106 (as described below), etc.). In general, the transaction data may include, for example, account numbers (e.g., primary account numbers (PANs), etc.) for payment accounts involved in the transactions, amounts of the transactions, merchant IDs for merchants involved in the transactions, merchant category codes (MCCs), dates/times of the transactions, products purchased and related descriptions or identifiers, payment account types, etc. It should be appreciated that more or less information related to transactions, as part of either authorization or clearing and/or settling, may be included in transaction records and stored within the system 100, at the merchant 102, the acquirer 104, the payment network 106, the target issuer 108, and/or the peer issuers 110a-c.

In various exemplary embodiments, the consumers involved in the different transactions herein are prompted to agree to legal terms associated with their payment accounts, for example, during enrollment in their accounts, during installation of payment applications to their communication devices, etc. In so doing, the consumers may voluntarily agree, for example, to allow merchants, issuers, payment networks, etc., to use data collected during enrollment and/or collected in connection with processing the transactions, subsequently for one or more of the different purposes described herein.

While one merchant 102, one acquirer 104, one payment network 106, and four issuers 108 and 110a-c are illustrated in FIG. 1, it should be appreciated that any number of these entities (and their associated components) may be included in the system 100, or may be included as a part of systems in other embodiments, consistent with the present disclosure.

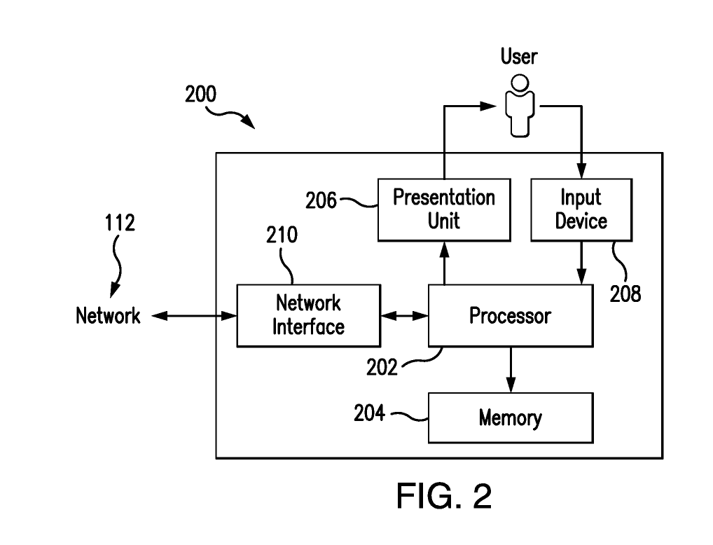

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the acquirer 104, the payment network 106, the target issuer 108, and the peer issuers 110a-c are illustrated as including, or being implemented in, computing device 200, coupled to (and in communication with) the network 112. In addition, the merchant 102 may be considered as including and/or being implemented in at least one computing device consistent with computing device 200. That said, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, issuer profiles, metrics, indicators, recommendations, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein. It should be appreciated that the memory 204 may include a variety of different memories, each implemented in one or more of the functions or processes described herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information (e.g., indicators of relative metrics, values of metrics, recommendations, etc.), visually, for example, to a user of the computing device 200, such as users associated with one or more of the issuers 108 and/or 110a-c, etc. And, various interfaces (e.g., as defined by network-based applications, etc.) may be displayed at computing device 200, and in particular at presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

In addition, the computing device 200 includes an input device 208 that receives inputs from the user (i.e., user inputs) such as, for example, user requests for a profile of the target issuer 108, as further described below. The input device 208 may include a single input device or multiple input devices. The input device 208 is coupled to (and is in communication with) the processor 202 and may include, for example, one or more of a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

Further, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other devices capable of communicating to one or more different networks, including the network 112. Further, in some exemplary embodiments, the computing device 200 includes the processor 202 and one or more network interfaces incorporated into or with the processor 202.

Referring again to FIG. 1, the target issuer 108 is provided to offer different payment account products (e.g., credit accounts, debit accounts, prepaid accounts, checking accounts, etc.) to consumers and/or other entities. The target issuer 108 includes, or is associated with, multiple users, including user 114. The users may include employees, managers, owners, etc. The user 114, for example, provides for and/or coordinates operation of the target issuer 108, on a business or technical level (e.g., facilitates operation of the issuer 108 consistent with the authorization requests and/or replies for various transactions as described above, etc.), and provides resources to maintaining and/or improving the target issuer 108 (e.g., by more efficient and/or additional services and/or products, etc.), etc. The user 114 is associated with a computing device 116, which, in this example, is consistent with the computing device 200. The user 114, via the computing device 116, communicates a request for a relative profile to a profile engine 118, which is also included in the system 100. To do so, the computing device 116 may interact with the profile engine 118, via the network 112, for example, through one or more interfaces associated with the profile engine 118, such as via a network-based application (e.g., a website, an application programing interface (API), etc.).

In addition, like the target issuer 108, the peer issues 110a-c are provided to offer different payment account products (e.g., credit accounts, debit accounts, prepaid accounts, checking accounts, etc.) to consumers and/or other entities. The description herein focusses, generally, on issuers that include all types of financial institutions that issue accounts, including, specifically, for example, payment accounts. With that said, it should also be appreciated that, in general, the acquirer 104 has issued an account associated with the merchant 102. As such, in various implementations, the acquirer 104 may also be an “issuer” in the context of the present disclosure (although this is not required in all implementations).

In this exemplary embodiment, the target issuer 108 and/or the peer issuers 110a-c are associated with specific characteristics, which may be indicative of the specific issuer, of the payment account products offered by the issuer, and/or of performance of the issuer in offering and/or maintaining the payment account products, etc. Table 1 illustrates a listing of exemplary characteristics, and their values, for each of the issuers 108 and 110a-c. In particular in this example, the characteristics include class (e.g., indicative of size and/or service coverage of the given issuer, etc.), different product types offered by the given issuer (i.e., Product Type 1 and Product Type 2), and a size of Portfolio 1 associated with the given issuer in billions of dollars (Gross Dollar Volume (GDV)).

TABLE 1

| Characteristic | Issuer 108 | Issuer 110a | Issuer 110b | Issuer 110c |
|---|---|---|---|---|
| Class | Regional | Regional | Regional | National |
| Product Type 1 | Credit | Credit | Credit | Credit |
| Product Type 2 | Debit | Debit | Debit | Debit |
| Portfolio 1 Size in | 4 | 10 | 8 | 23 |
| Billions of | | | | |
| Dollars (GDV) | | | | |

It should be understood that the characteristics herein are merely exemplary, and that other characteristics of the issuers 108 and 110a-c may be included and/or relied upon in other embodiments (e.g., location, number of locations, etc.). More specifically, as used herein, characteristics may be, may include, may relate to, etc. any aspect and/or feature of the issuers 108 and 110a-c, which may form a basis for comparison of the different issuers.

Also in this embodiment, each of the issuers 108 and 110a-c is associated with various different metrics (e.g., as determined via transaction data, etc.). Table 2 illustrates a listing of exemplary metrics, and their values, for each of the issuers 108 and 110a-c.

TABLE 2

| | Issuer | Issuer | Issuer | Issuer |
|---|---|---|---|---|
| Metric | 108 | 110a | 110b | 110c |
| Spend per Active Card | $1,205 | $1,407 | $989 | $1160 |
| Transactions per Active | 9.2 | 10.4 | 11.3 | 12.7 |
| Card | | | | |
| Percent of Spend per | 4% | 2.1% | 1.2% | 3.0% |
| Card that is Cross Border | | | | |
| Percent of Cross Border | 9% | 1% | 2.3% | 1.4% |
| Active Cards | | | | |
| Diversity of Merchant | 12 | 10 | 5 | 2 |
| Category Spend | | | | |
| Percent of Spend that is | 21% | 15% | 30% | 21% |
| E-Commerce | | | | |
| Percent of Cards with | 2.12% | 3.40% | 4.08% | 1.49% |
| Recurring Payment(s) | | | | |
| Authorization Rate | 27% | 10% | 9.4% | 4.2% |

Again, it should be understood that the metric(s) herein are merely exemplary, and that other metrics associated with the issuers 108 and 110a-c may be included and/or relied upon in other embodiments.

With continued reference to FIG. 1, the profile engine 118 of the system 100 is specifically configured, by computer executable instructions, to perform one or more of the operations described herein. In addition, the profile engine 118 is provided as a separate part of the system 100 and in communication with the payment network 106. As such, the profile engine 118 may be considered a computing device consistent with computing device 200. However, as indicated by the dotted line in FIG. 1, the profile engine 118 may be incorporated, partly or entirely, into the payment network 106 in various embodiments.

The system 100 also includes a profile data structure 120, which is coupled to and/or is accessible to (e.g., in communication with, etc.) the profile engine 118. The data structure 120 includes, for example, without limitation, transaction data for the target issuer 108 (e.g., metric values, etc.), transaction data for the peer issuers 110a-c, issuer recommendations, etc. (e.g., the data included in Table 2, etc.). The profile data structure 120 may be a standalone part of the system 100, as shown in FIG. 1, or it may be included in memory of the profile engine 118 (e.g., memory 204, etc.) or elsewhere in the system 100. It should be understood that the profile data structure 120 may be divided into separate structures, stored in separate parts of the system 100, and accessed from separate locations. For example, the data structure 120 may be included in the payment network 106, for its inclusion of transaction data for the issuers 108 and 110a-c (e.g., where the transaction data is mapped to an issuer based on issuer name and bank identification number (BIN), etc.), but may also be included in the profile engine 118 for its inclusion of profiles related to issuers (e.g., the target issuer 108, etc.).

With that said, generally in the system 100, the profile engine 118 is configured to receive a request for a relative assessment from the target issuer 108, and in particular, from the user 114, via the computing device 116. In one example, the profile engine 118 is configured to host a network-based application, which is accessible to the target issuer 108 (once registered and validated), via the network 112, through one or more credentials associated with the target issuer 108 (e.g., via a login procedure, etc.). Upon accessing the network-based application, the target issuer 108, and more particularly, the user 114, may have various options and/or access to multiple services associated with the target issuer 108. One such service, in this embodiment, includes the relative assessment service as generally described herein. In connection therewith, the target issuer 108, through the user 114, may be presented with a message requesting that the target issuer 108 consent to the profile engine 118 providing, generating, etc. the relative assessment (e.g., as part of confirming receipt of the request from the target issuer 108, prior to receiving the request from the target issuer 108, subsequent to receiving the request from the target issuer 108, etc.). In some embodiments, submission of the request by the target issuer 108 may serve as the consent.

In turn, upon receiving the request for the relative assessment from the target issuer 108, the profile engine 118 is configured to identify a set of peer issuers (e.g., one or more of the issuers 110a-c in this example, etc.), based on at least one characteristic of the target issuer 108. The characteristic(s) may include, without limitation, the number of issued accounts, location (or other regional limitation), portfolio size (GDV), etc. Again, Table 1 illustrates a listing of exemplary characteristics, and their values, for each of the issuers 108 and 110a-c. Depending on the desired characteristic, different sets of peer issuers may be identified by the profile engine 118 for the target issuer 108 (e.g., one set of peer issuers may be identified when the characteristic is class, while another set of peer issuers may be identified when the characteristic is product type; etc.).

Further, the profile engine 118 is configured to determine an aggregate value for one or more various metrics of the set of peer issuers. In this example, the peer issuers 110a-b are identified as being in the set of peer issuers for the target issuer 108 (based on the class characteristic), such that the profile engine 118 is configured to determine aggregate value(s) for metrics for each of the issuers 110a-b, from the data structure 120. The profile engine 118 may be configured to average or otherwise aggregate the values for the metrics for the peer issuers 110a-b and then to compare the values of the target issuer 108 and the aggregate values for the peer issuers 110a-b for one, or more, of the various metrics. The profile engine 118 is configured to then assign an indicator to the metric(s), based on the comparison of the values for the target issuer 108 and the aggregate value for the peer issuers 110a-b. In addition, based on the comparison (or a variation thereof) and/or the assigned indicators, the profile engine 118 is configured to identify one or more recommendations, per metric or multiple metrics, for the target issuer 108. The values for the particular metrics may be values for the metrics at particular times, or they may be values for the metrics over particular intervals (e.g., values for the last month, for the last quarter, for the last year, for a specific interval, etc.). In addition, in various implementations, the values for the particular metrics may be based on data that is anonymized or that is in aggregated form. Additionally, or alternatively, in various implementations, such data is only shared among ones of the issuers 108 and 110a-c that opt in and/or consent to the given analysis.

Then, the profile engine 118 is configured to transmit the indicators and/or the recommendations, if any, to the target issuer 108 (in response to the original request), via the network-based application, through which the request was received, or otherwise. The profile engine 118 may be further configured to permit the target issuer 108, and in particular, the user 114, via the computing device 116, to interact with the indicators and/or recommendation to view more or less details associated therewith (e.g., services offered by and/or through the profile engine 118, the payment network 106, etc.). It should be appreciated that any data transmitted to the target issuer 108 (if any such data is even transmitted at all), where such data is at least partially based on or associated with data of the peer issuers 110a-b, is transmitted in anonymized and/or aggregated form.

In various embodiments, certain additional recommendations (or categories of recommendations) may be available to the target issuer 108 for selection, from the profile engine 118, independent of the metrics for the issuer 108 (and/or not supported by the metrics for the issuer 108 because they are generally not based on transactional data/behavior). Such recommendations may include, for example, improve activation, reduce attrition and/or improve retention, and improve acquisition, etc. When selected, as with other recommendations, the issuer 108 is able to view/review various products, services, and/or marketing available to address them.

It should be appreciated that in addition to, or alternatively to, the above, the profile engine 118 and/or the data structure 120 may be configured otherwise to perform any of the operations described herein.

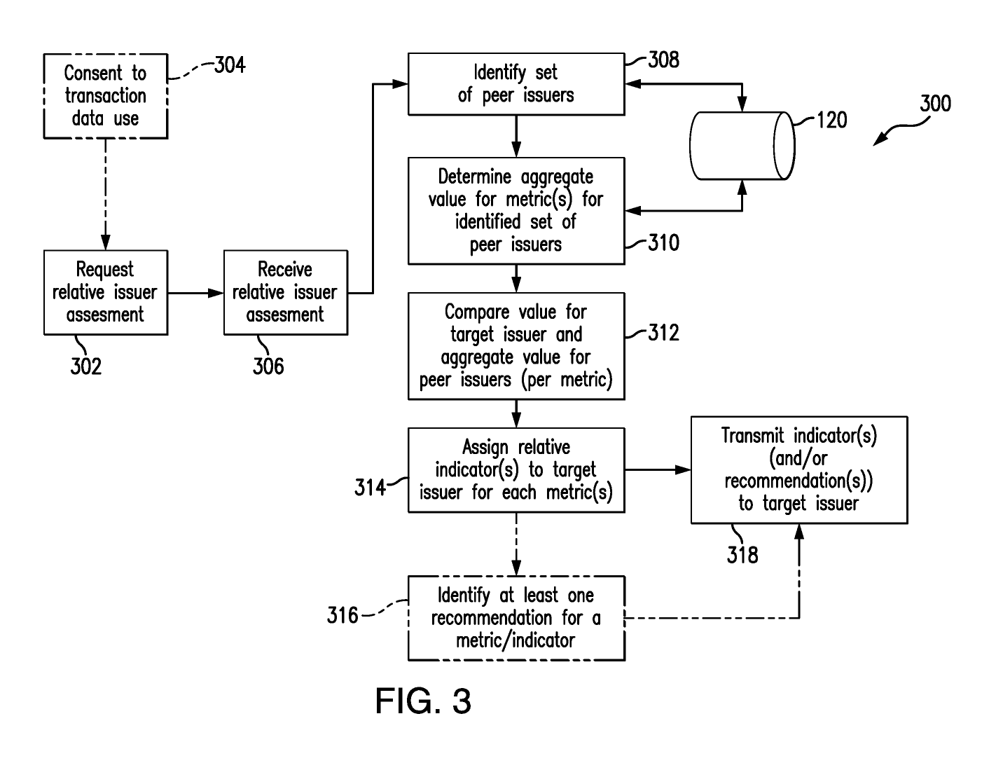

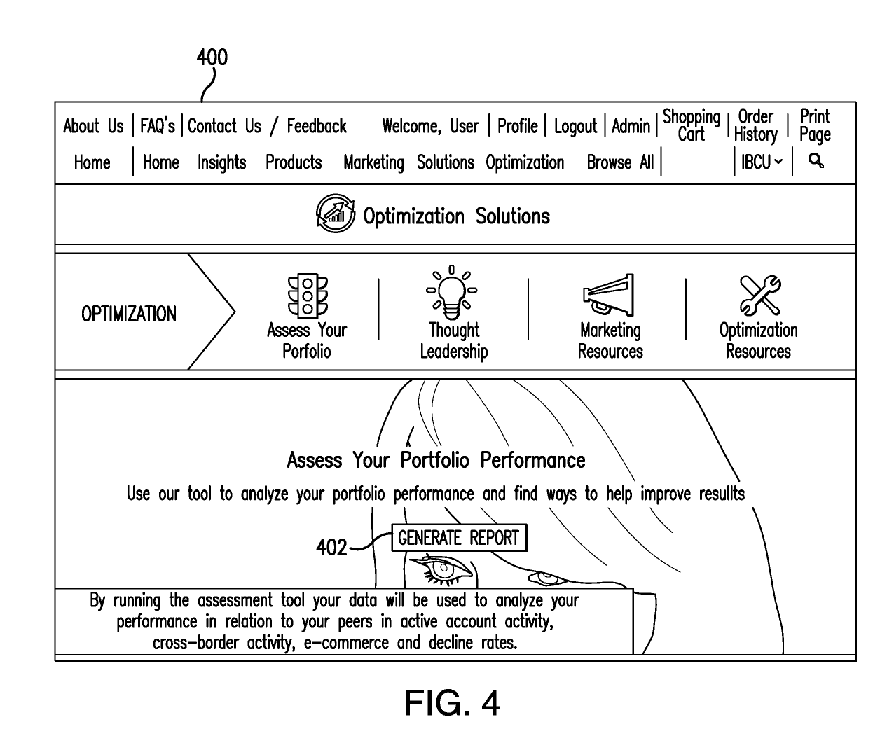

FIG. 3 illustrates an exemplary method 300 for use in providing indicator(s) and/or recommendations to a target issuer, based on at least one relative assessment for the target issuer and a group of peer issuers. The exemplary method 300 is described as implemented in the profile engine 118 of the system 100, in conjunction with the computing device 116 at the target issuer 109 and the data structure 120. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the exemplary method 300. Similarly, the method 300 is described with reference to exemplary interfaces 400-600 and 800, shown in FIGS. 4-6 and 8. As above, the method 300 (and other methods described herein), however, should not be understood to be limited to these particular interfaces 400-600 and 800, as various other interfaces, including the same and/or different content, may be employed in this and other method embodiments.

In the illustrated method 300, the target issuer 108 may wish to understand its performance and/or business, relative to one or more other issuers (e.g., relative to one or more of issuers 110a-c, etc.). To do so, the target issuer 108 (e.g., user 114, etc.) submits a request for a relative assessment to the profile engine 118, at 302. In connection therewith, FIG. 4 illustrates exemplary interface 400, which may be displayed to the user 114, at the computing device 116 (e.g., in response to the user 114 logging into a network-based application hosted by the profile engine 118 (e.g., via issuer name, user name and password, etc.) to thereby validate the target issuer 108, and selecting a service related to the profile engine 118, etc.). Then, in response to the interface 400, to request a relative issuer assessment (as part of the optimization solutions), the user 114 selects the “Generate Report” button 402, thereby requesting the assessment.

The request, as provided to the profile engine 118 by the target issuer 108 (at 302), may include merely a request with the name of the target issuer 108. In addition, in various implementations of the method 300, the request may further include, without limitation, characteristics associated with the target issuer 108 (e.g., class (e.g., national, super-regional, regional, credit union, other class indicative of size and/or service coverage, etc.), regions of operation/location, types of payment accounts offered/provided, etc.). It should be appreciated that content of the request as provided by the target issuer 108 (and/or as solicited by the profile engine 118) may be more or less, depending on, for example, whether the target issuer 108 is registered, or not, to the profile engine 118 (e.g., when the target issuer 108 is registered to the profile engine 118, various data relating to the target issuer 108 described herein may be previously provided to the profile engine 118 during such registration and stored in the data structure 120 for subsequent retrieval; etc.), etc. With that said, the data included in the request may be automatically included in the request based on the prior registration of the target issuer 108 (based on data stored in the data structure 120, etc.), or the target issuer 108 may provide some additional input to the request or all input to the request. For example, the target issuer 108 may provide input specifying a desired set of peer issuers for use in analysis (e.g., the target issuer 108 may provide specific characteristics to be used in identifying the set of peer issuers, etc.).

In connection with providing the request for the relative assessment to the profile engine 118, the target issuer 108 may also, optionally (as indicated by the dotted lines in FIG. 3), consent, at 304, to the use of the issuer's transaction data in the method 300 to provide the relative assessment (e.g., the target issuer 108, through the user 114, may be presented with a message requesting that the target issuer 108 consent to the profile engine 118 providing, generating, etc. the relative assessment; etc.). In addition, such consent may also relate to the use of the target issuer's transaction data in the method 300 in connection with providing assessments for other issuers, for example, when the method 300 is used by such other issuers (subject to certain privacy limitations). It should be appreciated that various different and/or additional types of consent may be optional, or required, in numerous embodiments of the method 300 for any involved ones of the issuers 108 and 110a-c, which may be applicable to the transaction data of the requested issuer, and/or other issuers, or otherwise. What's more, in various embodiments, any data used herein and/or transmitted to one or more of the issuers 108 and 110a-c may be based on data that is anonymized or that is in aggregated form.

In turn in the method 300, the profile engine 118 receives, at 306, the request for the relative issuer assessment, for example, via the network 112. At the same time (or later or earlier), the profile engine 118 may also receive any applicable consent(s) provided by the issuer 108 (at 304).

Next, the profile engine 118 identifies, at 308, a set of peer issuers for the target issuer 108. In particular, in this embodiment, the profile engine 118 retrieves, from the data structure 120 (or from the request, depending on the content of the request), one or more characteristics of the target issuer 108 and potential peer issuers (e.g., issuers 110a-c, etc.), and filters the potential peer issuers based on the retrieved characteristics. With respect to the target issuer 108 and the exemplary issuers 110a-c, the profile engine 118 may retrieve the four characteristics identified in Table 1 and filter the potential peer issuers 110a-c based on, for example, the class of the target issuer 108 (broadly, based on one or more of the characteristics). As such, based on the data in Table 1, the profile engine 118 may identify issuers 110a-b as peer issuers for the target issuer 108 (since the class for each is regional), but not the issuer 110c (since the class for issuer 110c is national). It should be appreciated that additional filters and/or different filters may be applied in various other embodiments. In various embodiments, the pool of peer issuers from which the peer issuers 110a-c are selected may only include issuers that have opted into, or consented to, the analysis features described herein.

Once the set of peer issuers are identified for the target issuer 108 (e.g., issuers 110a-b in the above example, etc.), the profile engine 118 determines, at 310, an aggregate value for one or more metrics for the peer issuers 110a-b. With reference to Table 2, for example, the profile engine 118 determines aggregate values for the peer issuers 110a-b, for each of the metrics: Spend per Active Card, Transaction per Active Card, Percent of Spend per Card that is Cross Border, Diversity of Merchant Category Spend, Percent of Spend that is E-Commerce, Percent of Cards with Recurring Payment(s), and Authorization Rate (e.g., based on anonymized transaction data for the given peer issuer, aggregated transaction data for the given peer issuer, etc.). In this embodiment, the values of each of the metrics are aggregated by averaging the values for the two peer issuers 110a-b. However, as can be appreciated, other manners of aggregating the metric values may be employed in other embodiments (e.g., averaging the values after eliminating top and bottom outliers, summing the values, determining a median of the values, etc.). Table 3 illustrates aggregate values for each of the metrics identified in Table 2, per metric, for the peer issuers 110a-b.

TABLE 3

| | | Aggregate | | |
|---|---|---|---|---|
| | | Value | | |
| | Metric for | for Peer | | |
| | target | Issuers | | Indi- |
| Metric | Issuer 108 | 110 a-b | Difference | cator |
| Spend per Active Card | $1,205 | $1,198 | 0.6% | G |
| Transactions per Active | 9.2 | 10.9 | −15.6% | Y |
| Card | | | | |
| Percent of Spend per | 4% | 1.7% | 135.3% | G |
| Card that is Cross | | | | |
| Border | | | | |
| Percent of Cross Border | 9% | 1.7% | 429.4% | G |
| Active Cards | | | | |
| Diversity of Merchant | 12 | 7.5 | 60% | G |
| Category Spend | | | | |
| Percent of Spend that is | 21% | 22.5% | −6.7% | Y |
| E-Commerce | | | | |
| Percent of Cards with | 2.12% | 3.74% | −43.32% | R |
| Recurring Payment(s) | | | | |
| Authorization Rate (as | 27% | 9.7% | 178.4% | G |
| percent of total | | | | |
| transactions) | | | | |

It should be appreciated that while the profile engine 118, in this embodiment, relies on multiple specific metrics, more or less metrics (e.g., only one metric, etc.) and/or different metrics than illustrated above may be employed by the profile engine 118 in other embodiments.

After determining the aggregate value(s) for the various metrics for the set of peer issuers 110a-b, the profile engine 118 next compares, at 312, the aggregate value to a corresponding value for the target issuer 108, per metric. For example, the profile engine 118 may calculate a percent difference between the values for the target issuer 108 and the peer issuers 110a-b, per metric. However, other comparisons may be performed in other embodiments (e.g., a numerical difference between the values instead of a percent difference, etc.). With that said, in the above example, the value for the target issuer 108 for the Spend per Active Card metric is $1,205, while the aggregate value for the peer issuers 110a-b for the same metric is $1,198, which yields a percent difference of 0.6% (i.e., (1,205−1,198)/1,198=0.006, or −0.6%), or the target issuer 108 outperforming the aggregate of the peer issuers 110a-b by about 0.6%. Similar comparisons are made for, and similar differences are determined for, the various other metrics included in Table 3, thereby providing a general indication of whether the target issuer 108 is outperforming the peer issuers 110a-b (as indicated by positive percent differences) or underperforming relative to the peer issuers 110a-b (as indicated by negative percent differences).

With continued reference to FIG. 3, the profile engine 118 also assigns indicators, at 314, to the target issuer 108, for each of the exemplary metrics. For example, the profile engine 118 may assign different indicators to the metrics indicative of the relative comparison of the metrics, such as R for red (i.e., a first indicator), Y for yellow (i.e., a second indicator), and G for green (i.e., a third indicator), which mean “needs immediate attention,” “needs improvement,” and “mastered,” respectively, in this example. Or, the profile engine 118 may assign numerical indicators to the metrics, generally corresponding to the comparison/difference in values determined above. In any case, the different indicators may be assigned based on deviation of the metric value for the target issuer 108, from the aggregate value for the peer issuers 110a-b, by certain threshold(s) (e.g., based on the percent differences between the values, etc.). In the above example, where the comparison involves determining percent differences in the metric values for the target issuer 108 and the peer issuers 110a-b, the percent differences may be compared to desired thresholds, where the threshold differences may be less than or equal to −20% for a red indicator, between −20% and 0% for a yellow indicator, and greater than or equal to 0% for a green indicator, etc.

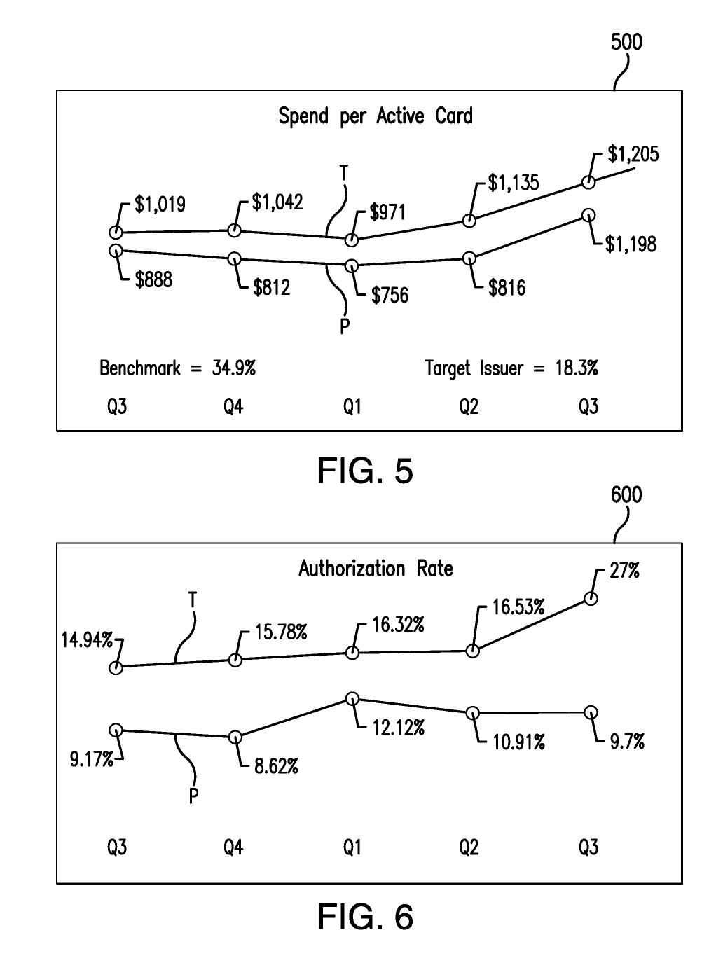

It should be appreciated that other indicators may be assigned by the profile engine 118 in other embodiments, and/or other thresholds for comparison may be used. In addition, other representations of indicators may be used. For example, in some embodiments a graphical representation of values for given metrics may be used/provided to thereby visually illustrate the indicators. In particular, a graphical interface may include, for a given metric, a line of the aggregate values for the peer issuers 110a-b over time (e.g., the last six months, year, five years, etc.), and a line indicative of the values for the target issuer 108 (broadly, providing an indicator), thereby showing the relative performance of the target issuer 108 to the peer issuers 110a-b, over time. With that said, FIGS. 5 and 6 illustrate exemplary graphical interfaces 500 and 600 for the Spend per Active Card metric and the Authorization Rate metric. In particular, the interface 500 of FIG. 5 illustrates line P indicative of aggregate values for the peer issuers 110a-b for the Spend per Active Card metric for a year-over-year (YoY) time frame and line T indicative of the corresponding values for the target issuer 108 for the same time frame. The interface 500 also includes a summary, for the YoY time frame, of the overall performance of the target issuer 108 (i.e., 18.3%) as well as the overall performance of the set of peer issuers 110a-b (i.e., the benchmark value of 34.9%). And, FIG. 6 illustrates line P indicative of aggregate values for the peer issuers 110a-b for the Authorization Rate metric for the YoY time frame and line T indicative of the corresponding values for the target issuer 108 for the same time frame.

In any case, once the indicators are assigned (and/or illustrated or otherwise represented), the profile engine 118 optionally (as indicated by the dotted lines in FIG. 3) identifies, at 316, one or more recommendations for the target issuer 108 based on the assigned indicator(s) and/or the underlying metric or metrics. Such recommendations may include, without limitation, recommendations to increase engagement, improve authorization, decrease fraud, consider product graduation, improve operational efficiencies, improve digital/mobile capabilities, etc.

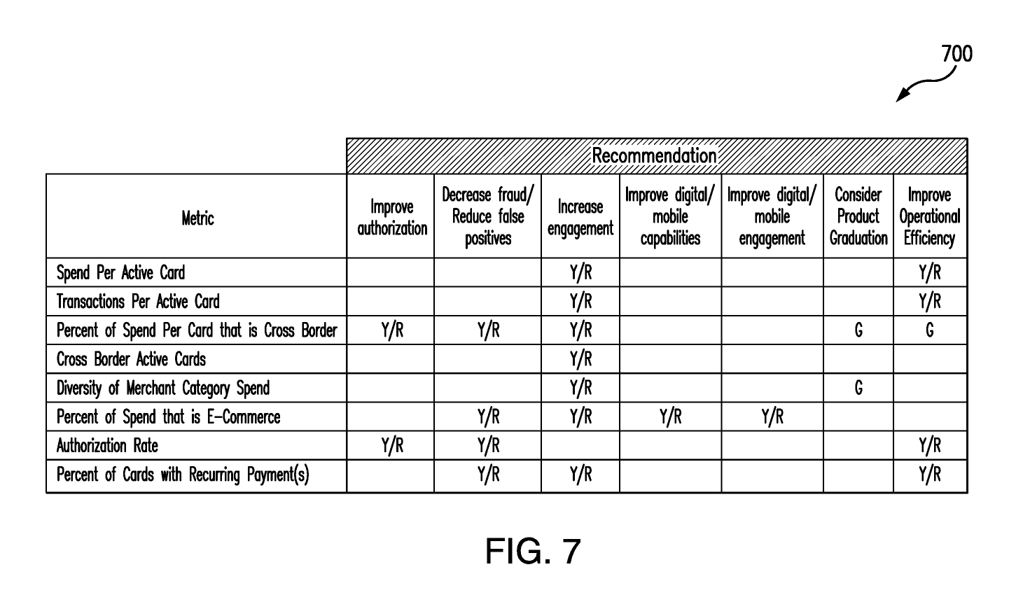

In one example, the particular recommendations for the target issuer 108 may be determined by the profile engine 118 through a mapping grid (e.g., stored in the data structure 120, etc.), which identifies particular recommendations for a given metric when the metric is associated with a particular indicator. In so doing, the particular recommendations may be based on potential causes for the given performance of the metric. For example, if the Spend per Active Card metric is underperforming (for the target issuer 108 in comparison to the peer issuers 110a-b), the potential causes may include budgeting and/or use of the card at low ticket merchants, low authorization rates/poor usage experience for the card, and/or that the card is a secondary card. In any case, the recommendations may then include improving operational efficiencies, increasing engagement, decreasing fraud, and product category expansion. As another example, if the Diversity of Merchant Category Spend is over performing (for the target issuer 108 in comparison to the peer issuers 110a-b), the potential causes may include that the card is a primary/top of the wallet card. And, the recommendations may then include that the target issuer 108 consider product gradation. With that said, FIG. 7 illustrates an exemplary mapping grid/table 700 that may be used by the profile engine 118 to identify recommendations for the target issuer 108, based on the assigned indicators in Table 3 for the various different metrics.

It should be appreciated that different recommendations may be mapped to multiple metrics, for example, via the mapping grid 700 of FIG. 7 or otherwise, etc., with multiple different recommendations being associated with a given metric (such that when an indicator for a given metric indicates that the target issuer 108 needs improvement, the mapping grid may identify multiple different recommendations to the target issuer 108 to provide such assistance). In turn, each of the recommendations may further be associated with particular products, services, marketing campaigns, etc. (via appropriate interfaces, etc.) that may assist the target issuer 108 (and/or be used by the target issuer 108) to improve values for the given metric(s). Table 4 includes various example recommendations that may be identified by the profile engine 118 for the above metrics, as evaluated in Tables 1-3, for the target issuer 108.

TABLE 4

| Metric | Difference | Indicator | Recommendation |
|---|---|---|---|
| Spend per Active Card | 0.6% | G | None |
| Transactions per Active | −15.6% | Y | Increase Engagement; |
| Card | | | Improve Operational Efficiency |
| Percent of Spend per | 135.3% | G | Consider Product Gradation; |
| Card that is Cross Border | | | Improve Operational Efficiency |
| Cross Border Active | 429.4% | G | None |
| Cards | | | |
| Diversity of Merchant | 60% | G | Consider Product Graduation |
| Category Spend | | | |
| Percent of Spend that is | −6.7% | Y | Decrease Fraud/Reduce False |
| E-Commerce | | | Positives; |
| | | | Increase Engagement; |
| | | | Improve Digital/Mobile |
| | | | Capabilities; |
| | | | Improve Digital/Mobile |
| | | | Engagement |
| Percent of Cards with | −43.32% | R | Decrease Fraud/Reduce False |
| Recurring Payment(s) | | | Positives; |
| | | | Increase Engagement; |
| | | | Improve Operational Efficiency |
| Authorization Rate | 178.4% | G | None |

Subsequently, after the indicators are assigned (and the recommendations potentially identified), the profile engine 118 transmits, at 318, the indicators (and recommendation(s), if any) to the target issuer 108, and in particular, the user 114, at the computing device 116. The profile engine 118 may transmit the indicators (and recommendation(s), if any), via the network-based application, or via a message (e.g., an email message, a text message, etc.) directed to the target issuer 108, or otherwise. Again, any data transmitted to the target issuer 108 is typically anonymized and/or in aggregated form (e.g., to inhibit disclosure of any data relating to or identifiable to any particular consumer, etc.).

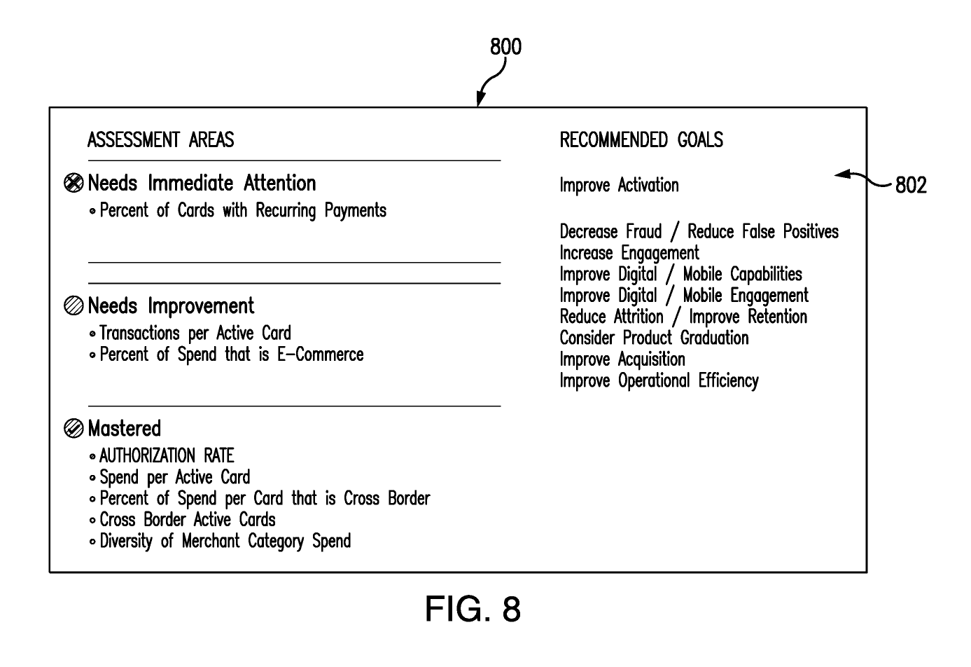

FIG. 8 illustrates exemplary interface 800, which may be displayed to the user 114, at the computing device 116, in which each of the metrics, for the target issuer 108, is listed under the appropriate indicator as assigned by the profile engine 118 (i.e., Needs Immediate Attention (red), Needs Improvement (yellow), and Mastered (green)) (e.g., based on the indicators identified in Table 3, etc.). In at least one embodiment, the indicators may include the metric for the target issuer 108 and the aggregate metric, as a benchmark, whereby the target issuer 108 is able to appreciate its relative performance more precisely. It should be appreciated that in such an embodiment, a population would be selected and/or defined for the set of peer issuers in order to sufficiently obscure the individual peer issuer data.

In addition, the exemplary interface 800 also includes a section 802 devoted to recommendations for the target issuer 108 (e.g., including the recommendations identified in Table 4, etc.). The user 114, in response to the exemplary interface 800, is able to select a recommendation from the section 802, whereby one or more additional interfaces (separately, or overlaid on interface 800) may be presented and may include additional details about the recommendation(s) or the indicator(s). The recommendation(s) may include, specifically, links and/or content related to services offered by the payment network 106, for example, which might aid the target issuer 108 in improving metrics which are not “mastered” in this example (or even further services when a metric is “mastered”). Section 802 also includes additional recommendations: improve activation, reduce attrition and/or improve retention, and improve acquisition. As indicated above, such additional recommendations may be available to the target issuer 108 for selection, from the profile engine 118, but are generally independent of the metrics for the issuer 108 (and/or are not supported by the metrics for the issuer 108 because they are generally not based on transactional data/behavior). However, as with the other recommendations provided, when such additional recommendations are selected, the issuer 108 is able to view/review various products, services, and/or marketing available to address them.

In view of the above, the systems and methods herein permit an issuer to realize a relative difference between its metrics and those issuers who are peer issuers. In particular, the profile engine described herein is situated and/or associated with the payment network, whereby, subject to consent and/or permissions, the profile engine is able to inform, through one or more indicators, a target issuer that its performance, according to one or more metrics, is at, below, or above the performance of its peer issuers. In this manner, the profile engine alters the flow of information to provide a concrete and useful result, over prior abilities of issuers to assess themselves against peer issuers, whereby the issuers are able to make informed decisions about offerings, etc., based on corresponding recommendations provided in accordance herewith.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated, based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) in response to a request, identifying, by a computing device, a set of peer issuers for a target issuer, based on at least one characteristic of the target issuer; (b) determining, by the computing device, an aggregate value of at least one metric for the identified set of peer issuers; (c) comparing, by the computing device, the aggregate value to a value of the at least one metric for the target issuer of the at least one metric for the target issuer; (d) assigning, by the computing device, an indicator to the target issuer, for the at least one metric, based on the comparison of the aggregate value and the value for the target issuer; (e) transmitting the indicator to the target issuer, thereby responding to the request and permitting the target issuer to assess a performance of the target issuer relative to the identified set of peer issuers; and (f) identifying at least one recommendation based on at least one of: the assigned indicator and the comparison of the value for the target issuer and the aggregate value.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in permitting assessments among different payment account issuers, the method comprising:
in response to a request for assessment, identifying, by a computing device, a set of peer issuers for a target issuer, based on at least one characteristic of the target issuer;
determining, by the computing device, an aggregate value of at least one metric for the identified set of peer issuers;
comparing, by the computing device, the aggregate value of the at least one metric for the identified set of peer issuers to a value of the at least one metric for the target issuer;
assigning, by the computing device, an indicator to the target issuer, for the at least one metric, based on the comparison of the aggregate value and the value for the target issuer; and
transmitting the indicator to the target issuer, thereby responding to the request and permitting the target issuer to assess a performance of the target issuer relative to the identified set of peer issuers for the at least one metric.

2. The computer-implemented method of claim 1, wherein the at least one characteristic includes a class of the target issuer, a product type offered by the target issuer, and/or a size of a portfolio associated with the target issuer.

3. The computer-implemented method of claim 1, wherein determining the aggregate value of the at least one aggregate metric includes determining an aggregate value for each of multiple metrics for the identified set of peer issuers; and
wherein comparing the aggregate value to the value for the target issuer includes, for each of the multiple metrics, includes comparing the aggregate value to a value of the metric for the target issuer.

4. The computer-implemented method of claim 3, wherein the multiple metrics include at least two of: a spend per active account, a cross-border active accounts, a spend per merchant category code (MCC), and an authorization rate.

5. The computer-implemented method of claim 1, wherein determining the aggregate value for the at least one metric includes averaging a value of the at least one metric for each of the peer issuers in the identified set.

6. The computer-implemented method of claim 5, wherein assigning the indicator includes assigning the indicator when the value for the target issuer deviates from the aggregate value for the at least one metric by more than a threshold.

7. The computer-implemented method of claim 1, wherein assigning the indicator includes assigning a first indicator when the value for the target issuer deviates from the aggregate value for the at least one metric by more than a threshold and assigning a second indicator when the value for the target issuer is within the threshold of the aggregate value for the at least one metric.

8. The computer-implemented method of claim 1, further comprising identifying at least one recommendation based on at least one of: the assigned indicator and the comparison of the value for the target issuer and the aggregate value.

9. The computer-implemented method of claim 8, wherein transmitting the indicator to the target issuer further includes transmitting the at least one recommendation to the target issuer.

10. A system for use in assessing payment account issuers, the system comprising:
a memory comprising a data structure having transaction data for multiple payment account issuers, and a recommendation table associated with multiple different issuer recommendations; and
a processor in communication with the memory, the processor configured to:
receive a request from a target issuer for assessment of the target issuer;
filter the multiple payment account issuers in the data structure based on at least one characteristic of the target issuer to thereby identify a set of peer issuers for the target issuer;
determine an aggregate value of at least one metric for the identified set of peer issuers;
assign at least one indicator to the target issuer for the at least one metric based on a comparison of a value of the at least one metric for the target issuer to the aggregate value; and
transmit the assigned at least one indicator to the target issuer, thereby responding to the request and permitting the target issuer to assess a performance of the target issuer relative to the identified set of peer issuers for the at least one metric.

11. The system of claim 10, wherein the at least one indicator includes a first indicator and a second indicator; and
wherein the processor is configured, in connection with assigning the at least one indicator to the target issuer, to:
assign the first indicator to the target issuer for the at least one metric when the comparison of the value of the at least one metric for the target issuer to the aggregate value is within a defined threshold; and
assign the second indicator to the target issuer for the at least one metric when the comparison of the value of the at least one metric for the target issuer to the aggregate value deviates from the defined threshold.

12. The system of claim 11, wherein the defined threshold is a first defined threshold; and
wherein the processor is configured, in connection with assigning the at least one indicator to the target issuer, to further assign a third indicator to the target issuer for the at least one metric when the comparison of the value of the at least one metric for the target issuer to the aggregate value deviates from the first defined threshold but is within a second defined threshold.

13. The system of claim 10, wherein the processor is configured, in connection with determining the aggregate value of the at least one metric, to determine an aggregate value for each of multiple metrics for the identified set of peer issuers; and
wherein, for each of the multiple metrics, the processor is configured, in connection with assigning the at least one indicator, to:
assign a first indicator to the target issuer for the metric when a comparison of a value of the metric for the target issuer to the corresponding aggregate value for the metric is within a defined threshold for the metric; and
assign a second indicator to the target issuer for the metrics when the comparison of the value of the metric for the target issuer to the aggregate value deviates from the defined threshold for the metric.

14. The system of claim 10, wherein the processor is further configured to compare the aggregate value of the at least one metric for the identified set of peer issuers to the value of the at least one metric for the target issuer.

15. The system of claim 14, wherein the at least one characteristic includes a class of the target issuer, a product type offered by the target issuer, and/or a size of a portfolio associated with the target issuer; and
wherein the at least one metrics includes at least two of: a spend per active account, a cross-border active accounts, a spend per merchant category code (MCC), and an authorization rate.

16. The system of claim 10, wherein the processor is configured to cause at least one interface to display at a computing device associated with the target issuer;
wherein the processor is configured, in connection with receiving the request from a target issuer for the assessment of the target issuer, to receive the request via the at least one interface; and
wherein the processor is configured, in connection with transmitting the assigned at least one indicator to the target issuer, to transmit the assigned at least one indicator to the target issuer via the at least one interface.

17. The system of claim 10, wherein the processor is further configured to identify at least one of the issuer recommendations in the memory based on at least one of: the assigned at least one indicator and the comparison of the value of the at least one metric for the target issuer to the aggregate value.

18. The system of claim 17, wherein the processor is configured, in connection with transmitting the at least one indicator to the target issuer, to transmit the at least one recommendation to the target issuer.

19. A non-transitory computer-readable storage media including executable instructions for assessing payment account issuers, which, when executed by a processor, cause the processor to:
receive a request for assessment from a target merchant via a network-based application;
identify a set of peer issuers for the target issuer, based on at least one characteristic of the target issuer;
determine an aggregate value of at least one metric for the identified set of peer issuers;
compare the aggregate value of the at least one metric for the identified set of peer issuers to a value of the at least one metric for the target issuer;
assign an indicator to the target issuer, for the at least one metric, based on the comparison of the aggregate value and the value for the target issuer; and
transmit the indicator to the target issuer via the network-based application, thereby responding to the request and permitting the target issuer to assess a performance of the target issuer relative to the identified set of peer issuers for the at least one metric.

20. The non-transitory computer-readable storage media of claim 19, wherein the executable instructions, when executed by the processor, further cause the processor to identify at least one recommendation in a data structure associated with the processor based on at least one of: the assigned indicator and the comparison of the value of the at least one metric for the target issuer to the aggregate value; and
wherein the executable instructions, when executed by the processor, further cause the processor, in connection with transmitting the indicator to the target issuer, to transmit the at least one recommendation to the target issuer via the network-based application.
